(19) United States
(12) Patent Application Publication
(10) Pub. No.: US 2024/0346664 A1
(43) Pub. Date: Oct. 17, 2024

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Akane ISEKI, Kanagawa (JP)

(21) Appl. No.: 18/621,158

(22) Filed: Mar. 29, 2024

(30) Foreign Application Priority Data
Apr. 14, 2023 (JP) 2023-066618

(51) Int. Cl. G06T 7/20; G06V 10/25; G06V 10/44

(52) U.S. Cl. CPC G06T 7/20; G06V 10/25; G06V 10/44; G06V 2201/07

(57) ABSTRACT

An image processing apparatus comprising one or more memories storing instructions and one or more processors that execute the instructions to acquire first information including likelihoods of tracking targets in a plurality of first candidates of the tracking target in a target image by using a tracking technique for tracking an object in an image, acquire second information including likelihoods of tracking targets in a plurality of second candidates of the tracking target in the target image by using a detection technique for detecting an object in an image, generate a determination reference for determining, based on the first information and the second information, whether a state is a lost state in which it is not possible to specify a tracking target, and determine, using the determination reference, whether the target image is set in a lost state.

### BACKGROUND

### Field

The present disclosure relates to a technique for tracking a tracking target in an image.

### Description of the Related Art

In recent years, a technique using a Deep Neural Network (to be referred to as an DNN hereinafter) has received a great deal of attention as a technique for accurately tracking a specific object in an image. For example, a Siam method represented by, for example, High Performance Visual Tracking with Siamese Region Proposal Network, Li et al., CVPR 2018 performs correlation operation in DNN features between a search range image and a reference image serving as a tracking target template, thereby detecting the tracking target from the search range image. In addition, it is difficult to extract a template indicating an object whose appearance changes in various ways. A combination with the prediction of the motion of the tracking target aims at robust tracking.

However, if the posture change and motion of the tracking target are very large, the tracker may enter a state in which the tracking target is lost, that is, in a state in which the tracking target enters the lost state. The tracking lost state can be a state in which an output of the tracking method as a combination of tracking and motion predictions using a template cannot be reliable.

As one method of solving the problem, there is available a method of switching a tracker and a detector at the time of determination of the lost state, like Japanese Patent Laid-Open No. 2020-149641. More specifically, if the lost state is determined during tracking, a tracking target is detected to acquire the template again by an objectness detection method (in place of the tracking method) of detecting an object-like region (having high objectness) like in FCOS: Fully Convolutional One-Stage Object Detection, Tien et al., ICCV 2019. This method aims at stable tracking by using the output of the detector as the tracking result if the lost state is determined. However, since the detector of the objectness detects only the object-like region, in order to discriminate, as the tracking target, one of the plurality of detection results, another information such as a motion prediction result is necessary. For this purpose, it is preferably assumed that tracking is performed by only the tracker and the detector is just used as an auxiliary unit as much as possible.

However, the current lost determination reference uses a predetermined reference regardless of the object and the ambient situation. In this case, there may be a case where although tracking is correct, the lost state is determined. For example, the reliability of the tracker is lower in a case where an analog is present than in a case where the analog is not present. The current lost determination does not consider the presence/absence of the analog. The way of motion of an object and easiness of its prediction change depending on objects. It is assumed that the prediction reliability of the motion should be estimated for each object. However, a difference between the objects is not considered in the current lost determination.

As a method of continuing tracking if the reliability of the tracker lowers and determining it as the lost state, there is a method of performing tracking using a combination of the tracker and a detector so as to update a template by using the detection result of the detector as the tracking result. In the conventional method, a common reference is used as the lost determination reference regardless of the tracking target and the ambient situation. For this reason, an appropriate reference may not be set for each frame, and the lost state is determined although the proper tracking is performed. Accordingly, the template updating is excessively performed. This makes it possible to cause a tracking failure.

### SUMMARY

The present disclosure provides a technique for generating an appropriate determination reference as a determination reference for determining whether the lost state as a state in which the tracking target cannot be specified is set.

According to the first aspect of the present invention, there is provided an image processing apparatus comprising one or more memories storing instructions and one or more processors that execute the instructions to: acquire first information including likelihoods of tracking targets in a plurality of first candidates of the tracking target in a target image by using a tracking technique for tracking an object in an image; acquire second information including likelihoods of tracking targets in a plurality of second candidates of the tracking target in the target image by using a detection technique for detecting an object in an image; generate a determination reference for determining, based on the first information and the second information, whether a state is a lost state in which it is not possible to specify a tracking target; and determine, using the determination reference, whether the target image is set in a lost state.

According to the second aspect of the present invention, there is provided an image processing method performed by an image processing apparatus, comprising: acquiring first information including likelihoods of tracking targets in a plurality of first candidates of the tracking target in a target image by using a tracking technique for tracking an object in an image; acquiring second information including likelihoods of tracking targets in a plurality of second candidates of the tracking target in the target image by using a detection technique for detecting an object in an image; generating a determination reference for determining, based on the first information and the second information, whether a state is a lost state in which it is not possible to specify a tracking target; and determining, using the determination reference, whether the target image is set in a lost state.

According to the third aspect of the present invention, there is provided a non-transitory computer-readable storage medium storing a computer program for causing a computer to function as: a first acquisition unit configured to acquire first information including likelihoods of tracking targets in a plurality of first candidates of the tracking target in a target image by using a tracking technique for tracking an object in an image; a second acquisition unit configured to acquire second information including likelihoods of tracking targets in a plurality of second candidates of the tracking target in the target image by using a detection technique for detecting an object in an image; a generation unit configured to generate a determination reference for determining, based on the first information and the second information, whether a state is a lost state in which it is not possible to specify a tracking target; and a determination unit configured to determine, using the determination reference, whether the target image is set in a lost state.

Further features of the present disclosure will become apparent from the following description of exemplary embodiments with reference to the attached drawings.

### BRIEF DESCRIPTION OF THE DRAWINGS

FIG. 1 is a block diagram showing an example of the hardware arrangement of an image processing apparatus;

FIG. 2 is a block diagram showing an example of the functional arrangement according to processing for inferring a tracking target in an image;

FIG. 3 is a flowchart showing processing performed by the image processing apparatus to infer the tracking target in the image;

FIG. 4 is a view showing an example of a reference image;

FIG. 5A is a view showing an example of a search image;

FIG. 5B is a view showing an example of a likelihood map;

FIG. 5C is a view showing an example of a BB;

FIG. 5D is a view showing an example of a movement penalty map;

FIG. 5E is a view showing an example of a map indicating a product result for elements between the likelihood map and the movement penalty map;

FIG. 6 is a view showing an example of a BB;

FIG. 7 is a block diagram showing an example of the arrangement of a hierarchical neural network;

FIG. 8 is a flowchart showing the details of processing in step S307;

FIG. 9 is a block diagram showing an example of the functional arrangement of an image processing apparatus according to learning;

FIG. 10 is a flowchart showing processing performed by the image processing apparatus for learning the parameter of a neural network at the time of inference;

FIG. 11 is a view showing an example of a reference image;

FIG. 12 is a view showing an example of a search image;

FIG. 13A is a view showing an example of a template feature; and

FIG. 13B is a view showing an example of an image feature of a search range image.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made that requires all such features, and multiple such features may be combined as appropriate. Furthermore, in the attached drawings, the same reference numerals are given to the same or similar configurations, and redundant description thereof is omitted.

### First Embodiment

This embodiment will describe a technique for inferring a tracking target in an image using a technique using a Siam method as a tracking technique for tracking an object in an image or an arbitrary object detection technique as a detection technique for detecting an object in an image.

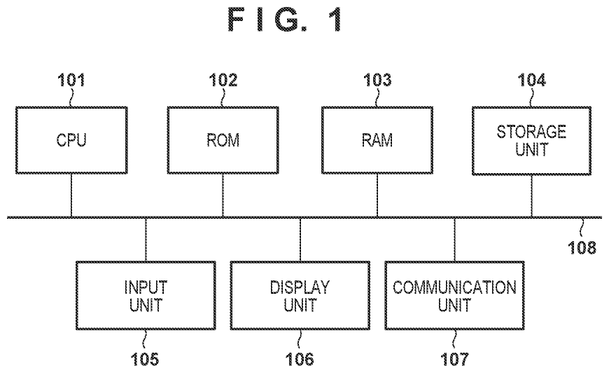

First, an example of the hardware arrangement of an image processing apparatus according to this embodiment will be described using the block diagram in FIG. 1. A computer apparatus such as a personal computer (PC), a tablet terminal device, a smartphone can be applied to the image processing apparatus according to this embodiment.

A CPU 101 executes various processes using computer programs and data stored in a RAM 103. Accordingly, the CPU 101 performs the operation control of the entire image processing apparatus and at the same time executes or control various processes explained as processing performed by the image processing apparatus.

A ROM 102 stores setting data of the image processing apparatus, the computer program and data according to activation of the image processing apparatus, the computer program and data according to the basic operation of the image processing apparatus, and the like.

The RAM 103 includes an area for storing the computer program and data loaded from the ROM 102 and a storage unit 104 and an area for storing the computer program and data received externally via a communication unit 107. In addition, the RAM 103 includes a work area used to execute various processes by the CPU 101. In this manner, the RAM 103 can appropriately provide various areas.

The storage unit 104 is a nonvolatile memory device such as a hard disk drive unit. The storage unit 104 stores an Operating System (OS) and the computer program and data and the like for causing the CPU 101 to execute and control various processes to be described as the processes executed by the image processing apparatus. Note that a flash memory, various kinds of optical media, or the like can be applied to the storage unit 104.

An input unit 105 is a user interface such as a keyboard, a mouse, a touch panel, a dial or the like, and can input various instructions and information to the image processing apparatus by user operations.

A display unit 106 includes a liquid crystal screen or touch panel screen and can display the processing result by the CPU 101 in the form of an image or characters. In addition, if the display unit 106 includes the touch panel screen, it can accept various use operations such as a touch operation from the user. Note that the display unit 106 may be a projection apparatus such as a projector for projecting an image or characters.

The communication unit 107 functions as a communication interface for performing data communication with an external device via a wired and/or wireless network such as a LAN or the Internet. In addition, the communication unit 107 also includes an interface connectable to an image acquisition device such as an image capturing device capable of performing capturing of a moving image and/or a still image.

All the CPU 101, the ROM 102, the RAM 103, the storage unit 104, the input unit 105, the display unit 106, and the communication unit 107 are connected to a system bus 108. Note that the hardware arrangement of the image processing apparatus according to this embodiment is not limited to the arrangement shown in FIG. 1, but can be changed/modified as needed.

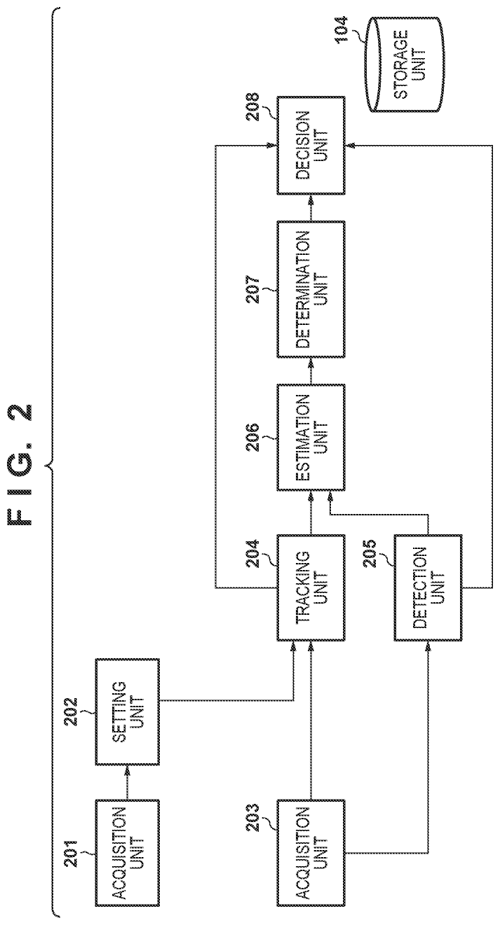

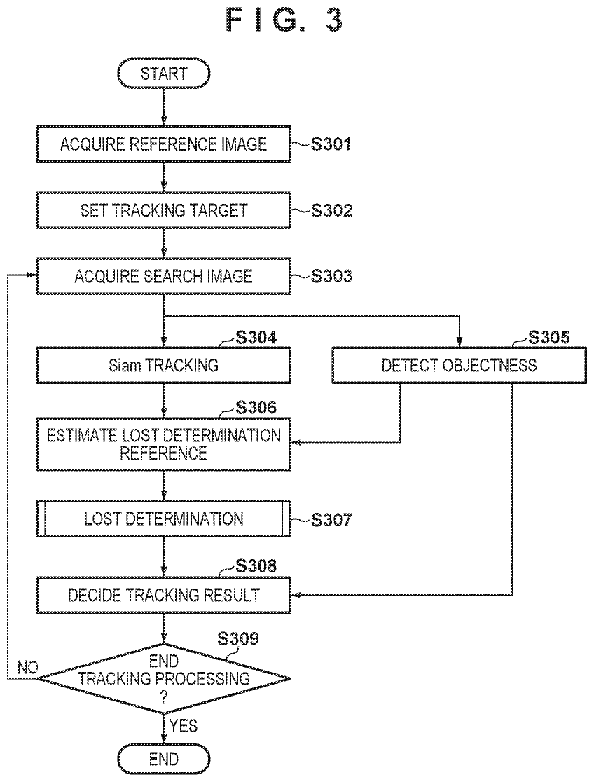

The example of the functional arrangement according to processing for inferring the tracking target in the image in the image processing apparatus according to this embodiment is shown in the block diagram of FIG. 2. In the following description, a case where the example of the functional units (except for the storage unit 104) shown in FIG. 2 is installed in the form of software (computer programs) will be described below. In the following description, a case where the functional units (except for the storage unit 104) shown in FIG. 2 serve as the main entity of the processing will be described. In practice, the computer programs corresponding to the functional units are executed by the CPU 101 to execute the functions of the functional units. Note that of the functional units shown in FIG. 2, at least one functional unit may be implemented by hardware. Processing executed by the image processing apparatus for inferring the tracking target in the image will be described in accordance with the flowchart in FIG. 3.

In step S301, an acquisition unit 201 acquires, as a reference image, an image including a tracking target (object). The method of acquiring a reference image is not limited to a specific acquisition method. For example, the acquisition unit 201 may acquire, as the reference image via the communication unit 107, the image of the tracking target obtained from the image capturing device or may acquire, as the reference image, the “image of the tracking target” stored in the storage unit 104.

In step S302, a setting unit 202 sets a Bounding Box (to be referred to as a BB hereinafter) surrounding the tracking target in the reference image acquired in step S301. When the reference image is displayed on the display unit 106 and the input unit 105 is operated to designate the object desired to be the tracking target by the user who observes the reference image displayed on the display unit 106, the setting unit 202 sets the BB surrounding the designated object.

The setting unit 202 then sets a peripheral region including the BB based on the position and size of the set BB and acquires, as a template image, the image obtained by resizing the image in the peripheral region to the defined size. For example, the setting unit 202 sets, as the peripheral region, the region obtained by enlarging the BB by a constant multiple of the size of the BB centered on the position of the center of the BB, and acquires, as the template image, the image obtained by resizing the image in the peripheral region to the defined size.

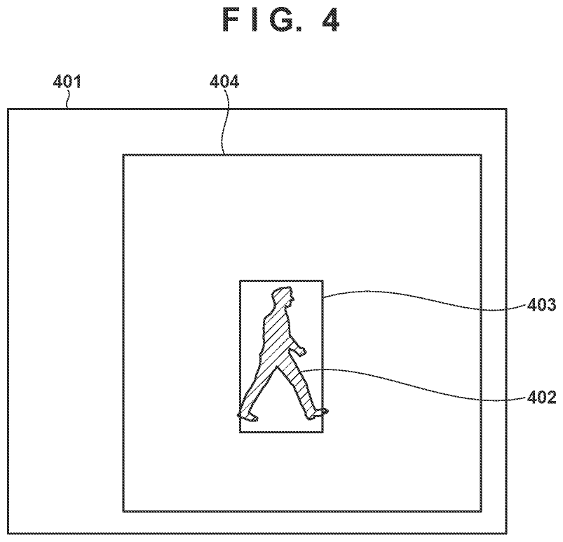

In an example of FIG. 4, a tracking target 402 in a reference image 401 is designated in response to a user operation, and a region 404 in a constant multiple of the vertical and horizontal size of a BB 403 of the tracking target 402 is set as a peripheral region. In this case, the setting unit 202 acquires, as a template image, an image obtained by resizing an image in the peripheral region 404 to the defined size.

In step S303, an acquisition unit 203 acquires, as a search image, an image (target image) serving as a target for searching for a tracking target. The search image may be, for example, an image of each frame in a moving image not including the above reference image or the search image may be an image of the second or succeeding frame in a moving image using the reference image as the start frame. Alternatively, the search image may be a still image different from the reference image. The search image acquisition method is not limited to a specific acquisition method. For example, the acquisition unit 203 may acquire, as the search image via the communication unit 107, the image of the tracking target obtained by the image capturing device. Alternatively, the acquisition unit 203 may acquire, as the search image, the “tracking target image” stored in the storage unit 104.

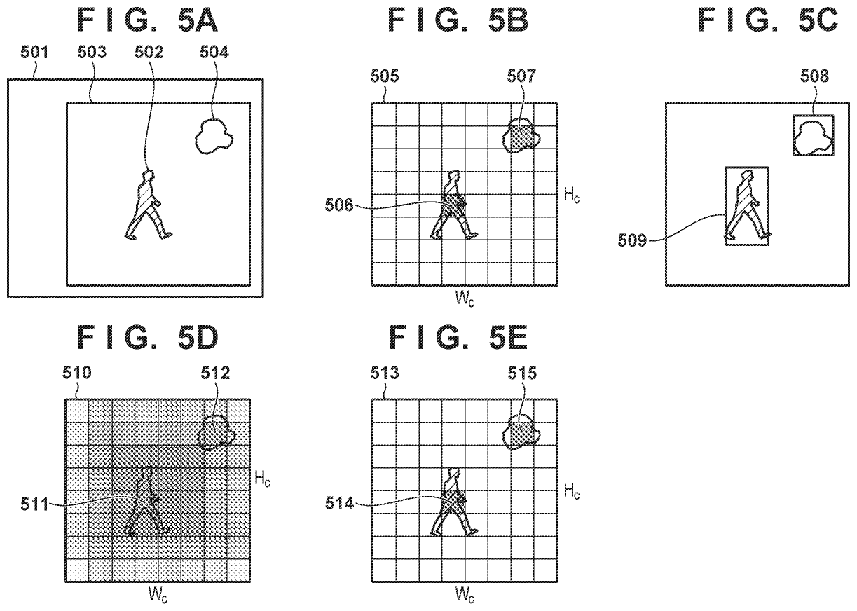

The acquisition unit 203 specifies an extraction region for extracting an image in the search range from the search image, based on the tracking target position (past position) and size (past size) inferred by preceding processing according to the flowchart in FIG. 3 for the search image acquired in the past from the search image. For example, the acquisition unit 203 sets the region having the past size at the past position in the search image and specifies, as the extraction region, a region obtained by enlarging the region by the constant multiple of the size of the region centered on the position of the center of the region. In the example of FIG. 5A, the region having the past size at the past position in a search image 501 including a tracking target 502 is set, and a region 503 obtained by enlarging the region by the constant multiple of the size of the region centered on the position of the center of the region is specified as the extraction region.

Note that if no search image acquired in the past from the search image exists, for example, if the search image is the start frame in the moving image or the search image is the image of the second frame (the start frame in the moving image is the reference image), the acquisition unit 203 specifies the extraction region in the same manner as described above based on the tracking target position (past position) and size (past size) in the reference image. The acquisition unit 203 then acquires, as the search range image, the image obtained by resizing the image in the extraction region to the defined size.

In step S304, a tracking unit 204 inputs the template image and the search range image to the tracker and performs various kinds of arithmetic processing operations. The tracker may use a method represented by the Siam method (High Performance Visual Tracking with Siamese Region Proposal Network, Li et al., CVPR 2018).

For example, the tracking unit 204 inputs the template image to a convolutional neural network (CNN) and performs CNN arithmetic processing, thereby acquiring the image feature (template feature) of the template image. The tracking unit 204 inputs the search range image to the CNN and performs the CNN arithmetic processing, thereby acquiring the image feature of the search range image. The tracking unit 204 performs correlation operation between the template feature and the image feature of the search range image. That is, the tracking unit 204 performs template matching with the template image for each position in the search range image to generate a likelihood map (the likelihood map strongly reacting with the position of the tracking target in the search range image) representing the “likelihood of the tracking target” corresponding to each position in the search range image, and a size map representing the “size of the tracking target” corresponding to each position in the search range image.

FIG. 5B shows an example of the likelihood map obtained from the image feature of the template image corresponding to the peripheral region 404 and the image feature of the search range image corresponding to the region 503. Each rectangle in FIG. 5B represents the pixel of a likelihood map 505. Each pixel of the likelihood map takes a real value of 0 to 1, and this value represents a degree of certainty (likelihood) of the tracking target. If the value of the pixel at the position where the tracking target exists is relatively larger than values of other pixels in the likelihood map 505, like the pixel 506, correct tracking can be performed. In addition, like a pixel 507, the value of the pixel in which an analog 504 exists like a pixel 507 tends to be large. The width and height of the likelihood map according to this embodiment are Wc and Hc, respectively, in the same manner as the likelihood map 505 of FIG. 5B, and are decided by the size of the search image and the arrangement of the CNN.

The tracking unit 204 selects, as selection likelihoods, a plurality of likelihoods in the descending order of magnitudes from the likelihoods registered at the respective positions of the likelihood map. In this embodiment, the “plurality of likelihoods in the descending order of magnitudes registered at the respective positions of the likelihood map” are upper M (M is an integer of 2 or more) likelihoods in the descending order of magnitudes from the likelihoods registered at the respective positions of the likelihood map. However, the definition of the “plurality of likelihoods in the descending order of magnitudes registered at the respective positions of the likelihood map” is not limited to this and may be given as likelihoods equal to or larger than the threshold of the likelihoods registered at the respective positions of the likelihood map.

For each selection likelihood, the tracking unit 204 acquires a set of the selection likelihood, the position where the selection likelihood is registered in the likelihood map, and the size corresponding to the position in the size map. More specifically, the tracking unit 204 acquires M 5-dimensional vectors each having, as elements, the [selection likelihood, x- and y-coordinates of the position where the selection likelihood is registered in the likelihood map, and the width and height registered at the position in the size map].

Here, the x- and y-coordinates represent x- and y-coordinates of the central position of the tracking target candidate on the likelihood map. The coordinate system has (0, 0) as the upper left corner of the likelihood map, an x-axis (positive in the right direction) in the width direction, and a y-axis (positive in the downward direction) in the height direction. If there are many analogs, BBs having a high likelihood are many. If the likelihood of the tracking target is decreased by posture variations or there are small analogs, many BBs having a low likelihood are included.

FIG. 5C shows a rectangular region (BB) defined by the respective vectors for M=2. A BB 508 has the width and height corresponding to the position of the pixel 507 in the size map and is a BB located at the position of the pixel 507. A rectangular region 509 has the width and height corresponding to the position of the pixel 506 in the size map and is a BB located at the position of the pixel 506.

In step S305, a detection unit 205 inputs the above search range image to an arbitrary object detector and performs arithmetic processing of the arbitrary object detector. The detection unit 205 outputs the objectness map and size map strongly reacting with the region having a high objectness (likelihood) (object-like) in the search range image.

The detection unit 205 selects, as the selection likelihoods, a plurality of likelihoods in the descending order of magnitudes of the likelihoods registered at the respective positions of the objectness map. According to this embodiment, the “plurality of likelihoods in the descending order of magnitudes registered at the respective positions of the objectness map” are upper M likelihoods of magnitudes of the likelihoods registered at the respective positions of the objectness map. However, the definition of the “plurality of likelihoods in the descending order of magnitudes registered at the respective positions of the objectness map” is not limited to this and may be given as likelihoods equal to or larger than the threshold of the likelihoods registered at the respective positions of the objectness map.

For each selection likelihood, the detection unit 205 acquires a set of the selection likelihood, the position where the selection likelihood is registered in the objectness map, and the size corresponding to the position in the size map. More specifically, the detection unit 205 acquires M 5-dimensional vectors each having, as elements, the [selection likelihood, x- and y-coordinates of the position where the selection likelihood is registered in the objectness map, and the width and height registered at the position in the size map].

The arbitrary object detector may use FCOS (FCOS: Fully Convolutional One-Stage Object Detection, Tien et al., ICCV 2019) or the like. The purpose of this step is to ascertain the presence/absence of an analog more robust in the estimation of lost determination reference in step S306. In consideration of the output of the tracking unit 204 obtained in step S304 and the output of the detection unit 205, an analog whose tracking likelihood is temporarily lowered due to the posture variation can be detected.

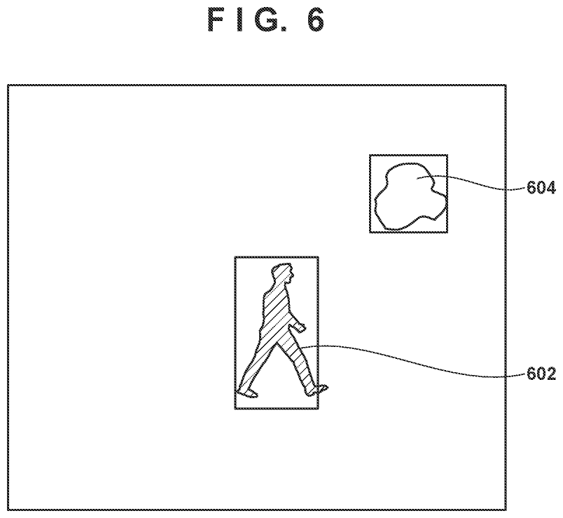

FIG. 6 shows a rectangular region (BB) defined by the respective vectors for M=2. A BB 604 has the width and height corresponding to the position of the pixel 507 in the size map and is a BB located at the position of the pixel 507. A BB 602 has the width and height corresponding to the position of the pixel 506 in the size map and is a BB located at the position of the pixel 506. One of the processing in step S304 and the processing in step S305 may be executed first, and then the other is executed next, but may be executed parallelly.

Next, in step S306, an estimation unit 206 generates a (10M×1)-dimensional integrated vector obtained by integrating M vectors generated by the tracking unit 204 and M vectors generated by the detection unit 205. The estimation unit 206 inputs the integrated vector to the lost determination reference estimator and performs the arithmetic processing of the lost determination reference estimator, thereby estimating the lost determination reference. The estimation unit 206 acquires a motion estimation parameter σ and a likelihood threshold θ as parameters of the lost determination reference. The motion estimation parameter σ is a one-dimensional parameter, and the likelihood threshold θ is a one-dimensional parameter which takes a real value of 0 to 1.

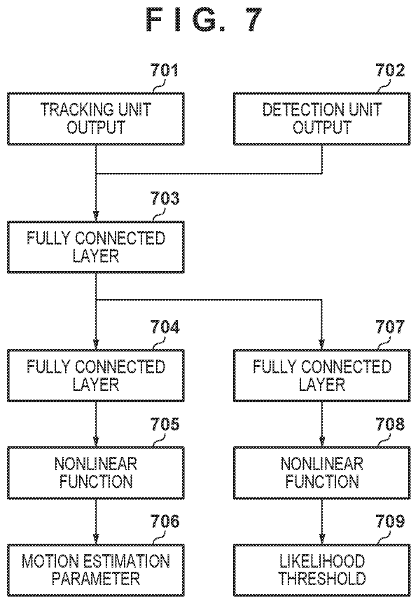

The lost determination reference estimator is, for example, a hierarchical neural network and includes fully connected layers 703, 704, and 707, and nonlinear functions 705 and 708 as exemplified in FIG. 7. A tracking unit output 701 as the M vectors generated by the tracking unit 204 and a detection unit output 702 as the M vectors generated by the detection unit 205 are input to the fully connected layer 703. The output from the fully connected layer 703 is input to the fully connected layer 704 and the fully connected layer 707. The output from the fully connected layer 704 is nonlinearly converted by the nonlinear function 705 and output as a motion estimation parameter 706. The output from the fully connected layer 707 is nonlinearly converted by the nonlinear function 708 and output as a likelihood threshold 709. Note that the arrangement of the hierarchical neural network applicable to the lost determination reference estimator, for example, the type of the nonlinear function and the number of fully connected layers are not limited to the arrangement shown in FIG. 7.

In step S307, a determination unit 207 determines, using the lost determination reference parameters (the motion estimation parameter σ and the likelihood threshold θ) acquired in the estimation in step S306, whether the lost state is set in the search image. Here, the “lost state in the search image” represents a state in which the tracking target cannot be specified from the output from the tracking unit 204 for the search image (search range image).

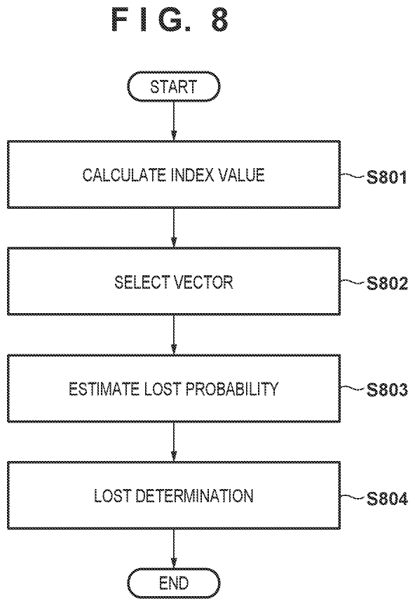

The details of processing in step S307 will be described according to the flowchart in FIG. 8. In step S801, the determination unit 207 obtains, as the movement penalty, the values corresponding to the vector elements “x- and y-coordinates” in a movement penalty map p defined by equation (1) below for the M vectors generated by the tracking unit 204.

The movement penalty map p is a map representing the penalty (movement penalty) for the moving amount of the tracking target. The movement penalty map p has a meaning like the probability of the moving amount of the tracking target and is designed to take a smaller value if a distance from the central position of the search range image is larger. For example, a hanning window may be used. In this case, the movement penalty map p is defined by equation (1):

$$p ( x , y ) = {window}_{{W}_{c}} ( x ) * {window}_{{H}_{c}} ( y ) \qquad ( 1 )$$

$$\{ \begin{matrix}{window}_{{W}_{c}} ( x ) = exp ( - \frac{2}{{{σ}^{2} ( {W}_{c} - 1 )}^{2}} {( x - \frac{{W}_{c} - 1}{2} )}^{2} ) \\ {window}_{{H}_{c}} ( y ) = exp ( - \frac{2}{{{σ}^{2} ( {H}_{c} - 1 )}^{2}} {( y - \frac{{H}_{c} - 1}{2} )}^{2} )\end{matrix}$$

p(x, y) represents the movement penalty corresponding to the position (x, y) in the likelihood map. As described above, the coordinate system has (0, 0) as the upper left corner of the likelihood map, an x-axis (positive in the right direction) in the width direction, and a y-axis (positive in the downward direction) in the height direction. FIG. 5D shows an example of the movement penalty map p corresponding to the likelihood map shown in FIG. 5B. In this example, the motion estimation parameter σ is set to a given value, and the movement penalty is calculated for each pixel of the likelihood map of the search range image, thereby visualizing it. The movement penalty in the movement penalty map p takes a value “1” at the center of the search range image, and a smaller value is taken if the distance from the central position of the search range image is larger. To the contrary, if the value of the motion estimation parameter σ is smaller, the decrease in the value of the movement penalty is abrupt.

The determination unit 207 then obtains as the index value, the product of the movement penalty obtained for each of the M vector generated by the tracking unit 204 and the element “selection likelihood” of the vector for each of the M vectors. FIG. 5E shows a map 513 representing the product for each element between the likelihood map 505 exemplified in FIG. 5B and the movement penalty map p shown in FIG. 5D.

The value (index value) of a pixel 514 in the map 513 is the value obtained by the product between the value (likelihood) of the pixel 506 in the likelihood map 505 in FIG. 5B and the value (movement penalty) of a pixel 511 of the corresponding position in a movement penalty map 510 in FIG. 5D.

The value (index value) of a pixel 515 in the map 513 is the value obtained by the product between the value (likelihood) of the pixel 507 in the likelihood map 505 in FIG. 5B and the value (movement penalty) of a pixel 512 of the corresponding position in a movement penalty map 510 in FIG. 5D.

In step S802, the determination unit 207 specifies, as the target vector, the vector corresponding to the maximum index value of the index values obtained in step S801. In the case of an example in FIGS. 5A to 5E, the vector corresponding to a BB 509 of the object located in the pixel 514 is specified as the target vector.

By applying the movement penalty to the likelihood to select the tracking target vector, the estimation result of the tracking unit 204 is combined with the movement penalty representing the motion prediction of the tracking target to allow the estimation of the tracking target. In addition, if the parameter σ is smaller, the allowable range of the movement of the tracking target is narrowed, and the importance is attached to the motion prediction as compared to the estimation result of the tracking unit 204.

In step S803, the determination unit 207 inputs a likelihood threshold θ acquired in step S306 and the element “selection likelihood pmax” of the target vector specified in step S802 to the lost probability estimator such as the hierarchical neural network. The determination unit 207 then performs the arithmetic processing of the lost probability estimator to obtain the lost probability π. Here, a case where the lost probability estimator is the hierarchical neural network will be described below. The determination unit 207 obtains a vector Plost defined by the lost probability π in accordance with, for example, equation (2) below:

$${p}_{lost} = [ π , 1 - π ] = gumbel\_softmax ( FC ( [ θ , {p}_{max} ] ) ) \qquad ( 2 )$$

where [θ, pmax] represents the two-dimensional vector in which the likelihood threshold θ and the selection likelihood pmax are aligned, and FC represents the fully connected layer. gumbel_softmax (Categorical reparameterization with gumbel-softmax. Jang et al., ICLR 2017) is a function obtained by replacing sampling of the one-hot vector from the categorical distribution with differentiation enable function and is defined by equation (3) below;

$$gumbel\_softmax ( x ) = softmax ( ( log ( x ) + g ) / τ ) \qquad ( 3 )$$

$$g = - log ( - log ( u ) ) , u ∼ Uniform ( 0 , 1 )$$

where τ is a positive constant and represents the temperature parameter of the softmax function. If τ comes close to 0, the vector to be generated comes close to the one-hot vector. By using the gumbel_softmax, the sampling processing from the categorical distribution using the lost probability π can be differentiated. Accordingly, by using the error backpropagation method, the parameter of the lost determination reference estimator in the estimation unit 206 and the parameter of the lost probability estimator in the determination unit 207 can be end-to-end learned.

In step S804, the determination unit 207 performs the arithmetic operation represented by equation (4) below using the vector Plost obtained in step S803 to obtain a vector ylost[y1, y2] as the lost determination reference:

$${y}_{lost} [ y 1 , y 2 ] = Round ( [ π , 1 - π ] ) \qquad ( 4 )$$

where Rounf( ) is a function for returning the rounding off result. In the case of equation (4), the π rounding off result is substituted into y1 as the first element of the vector ylost, and the (1−π) rounding off result is substituted into y2 as the second element of the vector ylost.

If ylost[y1, y2]=[1, 0], the determination unit 207 determines that the state is the lost state. If ylost[y1, y2]=[0, 1], the determination unit 207 determines that the state is not the lost state.

Referring back to FIG. 3, in step S308, a decision unit 208 outputs the tracking result of the tracking target corresponding to the lost determination result in step S307. If the determination unit 207 determines that the state is not the lost state, the decision unit 208 outputs, as the tracking result of the tracking target, the target vector specified in step S802 or the information derivable from this target vector. If the determination unit 207 determines that the state is the lost state, the decision unit 208 outputs, as the tracking result of the tracking target, the vector having the highest selection likelihood of the M 5-dimensional vectors acquired by the detection unit 205 in step S305 or the information derivable from this target vector.

For example, the decision unit 208 may output the vector elements “x- and y-coordinates” (the position of the tracking target) and the vector elements “width and height” (the size of the tracking target) as the tracking result of the tracking target.

In step S309, the decision unit 208 determines whether an end condition for ending the inference processing according to the flowchart in FIG. 3 is satisfied. The “end condition for ending the inference processing” is, for example, a condition that “the search image acquired in step S303 is the end frame in the moving image”, a condition that “the user operates the input unit 105 to input the end instruction”, or the like.

If the end condition is satisfied as the result of such a determination, the processing according to the flowchart in FIG. 3 ends. If the end condition is not satisfied, the process advances to step S303.

Note that in this embodiment, the parameters for the tracker used by the tracking unit 204, the arbitrary object detector used by the detection unit 205, the lost determination reference estimator used by the estimation unit 206, and the hierarchical neural network used by the determination unit 207 are learned in advance and stored in a storage unit 209. The CPU 101 then reads out the parameters from the storage unit 104 as needed and sets the parameters in the tracker, the arbitrary object detector, the lost determination reference estimator, the hierarchical neural network, and the like.

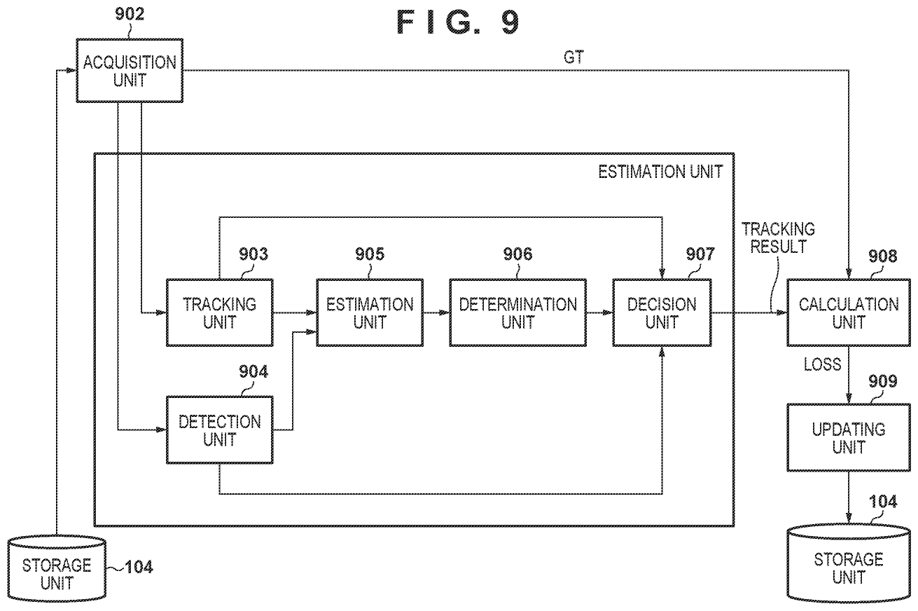

The image processing apparatus for leaning the parameter of the abovementioned neural network used at the time of inference will be described next. The functional arrangement example of the image processing apparatus according to leaning is shown in the block diagram shown in FIG. 9. A case where the functional unit (except the storage unit 104) shown in FIG. 9 is implemented by software (the computer program) will be described below. In the following description, a case where the functional unit (except the storage unit 104) shown in FIG. 9 is the main entity of processing will be described, but the function of the functional unit is executed by the CPU 101 actually executing the computer program corresponding to the functional unit. Note that one or more functional units shown in FIG. 9 may be implemented by hardware.

Note that a tracking unit 903, a detection unit 904, an estimation unit 905, a determination unit 906, and a decision unit 907 are functional units having the same functions as the tracking unit 204, the detection unit 205, the estimation unit 206, the determination unit 207, and the decision unit 208, respectively.

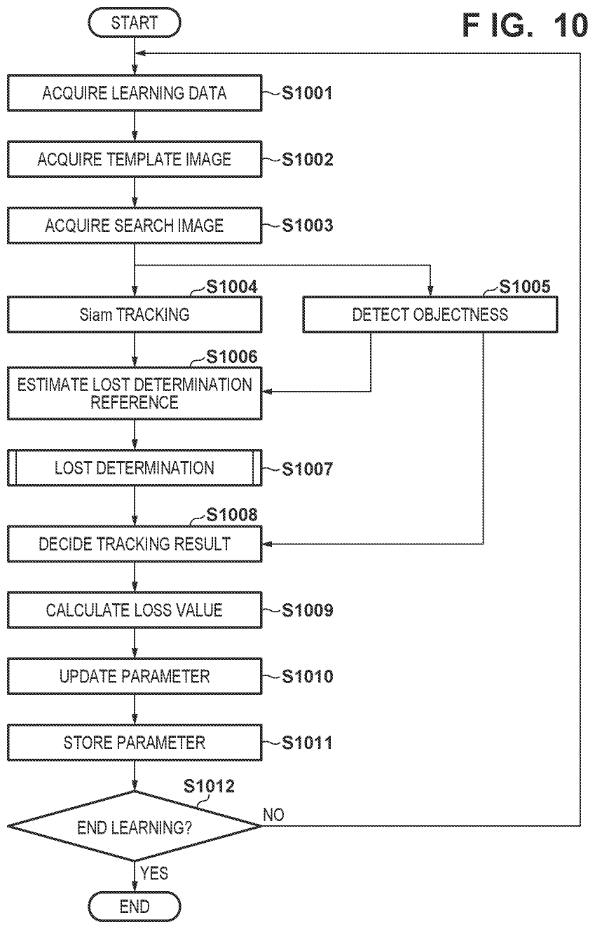

The processing performed by the image processing apparatus for learning the parameter of the above neural network used at the time of inference will be described in accordance with a flowchart in FIG. 10. In step S1001, an acquisition unit 902 acquires learning data from the storage unit 104. The learning data includes N sets (N is an integer of one or more) each including one reference image and one search image including the same tracking target, and correct data representing the position (the x- and y-coordinates) and the size (the width and height) of the tracking target in each of the reference image and the search image. The correct data is referred to as a Ground Truth (GT) hereinafter. In the following description, a case for N=1 will be described below. The definitions of the reference image and the search image have been described above.

In step S1002, in the same manner as in the setting unit 202, the acquisition unit 902 acquires, from the reference image, a template image based on a BB having a size of the GT at the position indicated by the GT of the reference image.

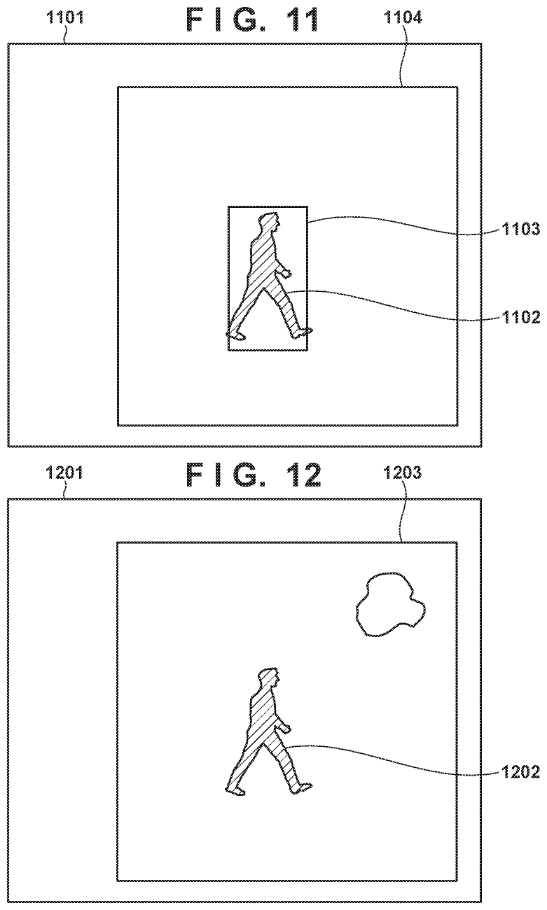

An example of the reference image is shown in FIG. 11. The acquisition unit 902 defines the position of the center of a “BB 1103 of a tracking target 1102” defined by the GT of a reference image 1101 as the center and sets, as a peripheral region 1104, a region obtained by enlarging the BB 1103 by the constant multiple of the size of the BB 1103. The acquisition unit 902 acquires, as the template image, the image obtained by resizing the image in the peripheral region 1104 to the defined size.

In step S1003, in the same manner as in the acquisition unit 203, the acquisition unit 902 acquires, from the search image, the search range image based on the region having the size represented by the GT at the position indicated by the GT of the search image. In the example of FIG. 12, a region 1203 obtained by enlarging the region by the constant multiple of the size of the region centered on the central position of the region having the size represented by the GT at the position indicated by the GT of a search image 1201 including a tracking target 1202 is specified. The acquisition unit 902 acquires, as the search range image, the image obtained by resizing the image in the region 1203 to the defined size.

In step S1004, in the same manner as in the tracking unit 204, the tracking unit 903 inputs the template image and the search range image to the tracking unit and performs various kinds of arithmetic processing operations. Accordingly, the tracking unit 903 acquires M 5-dimensional vectors each including, as elements, the [selection likelihood, the x- and y-coordinates of the position where the selection likelihood is registered in the likelihood map, and the width and height corresponding this position in the size map].

In step S1005, in the same manner as in the detection unit 205, the detection unit 904 inputs the search range image to the arbitrary object detector and performs the arithmetic processing of the arbitrary object detector. Accordingly, the detection unit 904 acquires M 5-dimensional vectors each including, as elements, the [selection likelihood, the x- and y-coordinates of the position where the selection likelihood is registered in the objectness map, and the width and height corresponding this position in the size map].

In step S1006, in the same manner as in the estimation unit 206, the estimation unit 905 generates a (10M×1)-dimensional integrated vector obtained by integrating M vectors generated by the tracking unit 903 and M vectors generated by the detection unit 904. The estimation unit 905 then inputs the integrated vector to the lost determination reference estimator and performs the arithmetic processing of the lost determination reference estimator, thereby acquiring the motion estimation parameter σ and the likelihood value θ as the parameters of the lost determination reference.

In step S1007, in the same manner as in the determination unit 207, the determination unit 906 generates the lost determination reference using the motion estimation parameter σ and the likelihood value θ and determines, using the generated lost determination reference, whether the state in the search image is the lost state. In step S1008, in the same manner as in the decision unit 208, the decision unit 907 outputs the tracking result of the tracking target in accordance with the lost determination result in step S1007.

In step S1009, a calculation unit 908 obtains a loss value for the tracking result of the tracking target output in step S1008. For example, the calculation unit 908 obtains a loss value Loss for the overlap between a BB (to be referred to as a first BB) defined by the elements “the x- and y-coordinates and the width and height” of the target vectors and a BB (to be referred to as a second BB) of the tracking target defined by the GT of the search image.

The calculation unit 908 calculates the overlap between the first BB and the second BB as an IOU of the two BBs as indicated by equation (5). In this case, the IOU is an index representing the overlap of the two BBs. In addition, BBinf represents the first BB, and BBgt represents the second BB:

$$IoU = \frac{{BB}_{inf} ⋂ {BB}_{gt}}{{BB}_{inf} ⋃ {BB}_{gt}} \qquad ( 5 )$$

Next, the calculation unit 908 performs the arithmetic operation according to equation (6) using the IOU obtained by equation (5) to obtain the loss value Loss. The loss value Loss is the loss value in which if the overlap between the two BBs is decreased, the loss value is increased.

$$Loss = \frac{1}{N} \sum ( 1 - IOU ) \qquad ( 6 )$$

where N represents the number of sets of BBinf and BBgt. If the overlap between BBinf and BBgt is small, the IOU value calculated by equation (5) is decreased, and the loss value Loss calculated by equation (6) is increased. When learning is performed such that the loss value is decreased, the overlap between BBinf and BBgt is increased, and the BB to be estimated comes close to the GT.

Here, the loss value is described in the form of an IOU loss (Unitbox: An advanced object detection network. Yu et al., ACMMM 2019). However, the loss value is not limited to this, but may be a generalized IOU loss (Generalized Intersection over unit: A metric and a loss for bounding box regression. Rezatofighi et al., CVPR 2019) or the like. The calculation formula of the loss value is not limited to a specific one.

In step S1010, an updating unit 909 performs learning processing of the neural network by the error backpropagation method based on the loss value Loss obtained in step S1009, thereby updating the parameter of the neural network. By this learning processing, the weight parameter of the fully connected layer of each neural network such as the hierarchical neural network shown in FIG. 7 and the hierarchical neural network for performing the arithmetic operation indicate by equation (2) is updated. In addition, the weight parameter of a convolution layer or the like of the neural network in each of the tracking unit 903 and the detection unit 904 may be fixed.

In step S1011, the updating unit 909 stores, in the storage unit 104, the parameter of the neural network updated in step S1010. After that, the estimation unit 905 reads out the parameter of the hierarchical neural network as the lost determination reference estimator from the storage unit 104 and sets it in the hierarchical neural network. In addition, the determination unit 906 reads out the parameter of the hierarchical neural network as the lost probability estimator from the storage unit 104 and sets it in the hierarchical neural network. In this manner, each functional unit using the neural network reads out the parameter corresponding to the neural network from the storage unit 104 and sets it in the neural network. The procedure up to this point is given as one-iteration learning.

In step S1012, the updating unit 909 determines whether the learning end condition is satisfied. The learning end condition is not limited to a specific end condition. For example, the learning end condition includes a condition that the learning count is equal to or larger than the threshold, a condition that the learning error value (for example, the loss value Loss in equation (6)) is equal to or less than the threshold, a condition that a rate of change in the error is equal to or less than the threshold, a condition that the time elapsed from the start of learning is equal to or longer than the defined time, and the like.

As a result of this determination, if the learning end condition is satisfied, the processing according to the flowchart in FIG. 10 ends. On the other hand, if the learning end condition is not satisfied, the process advances to step S1001.

As described above, according to this embodiment, the reliability reference of the output from the tracker, that is, the lost determination reference is estimated for each image to perform the lost determination at an appropriate timing and improve tracking performance of a combination of the tracker and the detector.

As factors of the loss, it is assumed that the analog exists or does not exist and the motion of the tracking target is abrupt. By learning the relationship between these factors and the lost determination reference, the lost reference can be adapted for each image.

By estimating the presence/absence of the analog and the lost determination reference using the outputs from the tracker and the detector as inputs, even if the posture variations of the tracking target and analog used for estimation of the lost determination reference are abrupt, the presence/absence of the analog is ascertained robustly, and lost determination can be performed.

### Modification 1 of First Embodiment

If the start frame in the moving image is used as the reference image, in the first embodiment, the template image acquired by the processes in steps S301 and S302 for the start frame is used in processing for the succeeding frames.

To the contrary, in this modification, if it is determined that the state is the lost state, the template image is updated to a new template image (the template image to be used next by the tracker is updated to a new template image).

As the lost determination result in step S307, if it is determined that the state is the lost state, a setting unit 202 acquires, as the template image, the image obtained by resizing the image in the corresponding region in the search image corresponding to the peripheral region set in step S302 to the defined size.

If the tracker continues to perform tracking using the same template image, and the state temporally becomes the lost state due to a change in posture of the tracking target, the lost state continues from the current and subsequent times at a high possibility. According to this modification, when the template image is updated at the time of lost state, the tracker can easily recover the non-lost state from the lost state.

### Second Embodiment

In each of the following embodiments including the second embodiment, a difference from the first embodiment will be described. Unless specifically mentioned, the matters are the same as in the first embodiment. In the second embodiment, a method of estimating the lost determination reference in a tracking task obtained by combining a detector and a tracker as in the first embodiment will be described. The difference from the first embodiment is given such that the image feature of the tracking target is included as the input to the lost determination reference estimator.

The tacker used in a tracking unit 204 employs a template matching method in the image features between the template image and the search image. In the following description, as in the first embodiment, an Siam method of High Performance Visual Tracking with Siamese Region Proposal Network, Li et al., CVPR 2018 is assumed and described. However, the method is not limited to the method.

As in the first embodiment, even in the second embodiment, the processing performed by the image processing apparatus for inferring the tracking target in the image is processing according to the flowchart in FIG. 3. However, processing in step S304 is different from the first embodiment. Therefore, processing in step S304 according to the second embodiment will be described below.

In step S304, the tracking unit 204 acquires M (5M+1) vectors each having, as elements, the [selection likelihood, x- and y-coordinates of the position where the selection likelihood is required in the likelihood map, and the width and height registered at the position in the size map] by using the tracker as in the first embodiment.

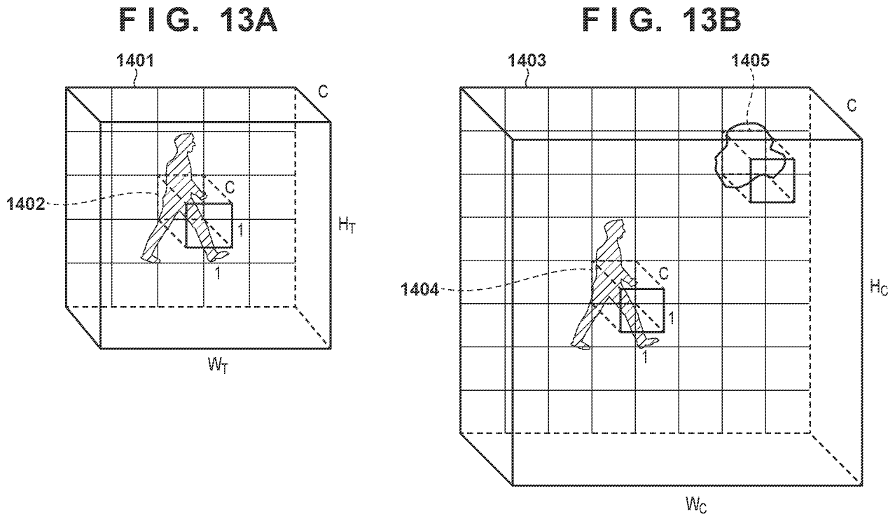

The tracking unit 204 then acquires the feature vector corresponding to the central pixel in the template features. Here, if the size of the template feature is set as WT (width)×H (height)×C (channel count) (where C is a positive constant), the size of the feature vector is 1×1×C. FIG. 13A shows an example of a template feature 1401 having a size of WT (width)×HT (height)×C (channel count). As described above, the size of a feature vector 1402 corresponding to the central pixel in the template feature 1401 is 1×1×C. The WT, HT, and C are values determined by the structure of the neural network used by the tracker.

The tracking unit 204 modifies the feature vector having the size of 1×1×C into a feature vector having a size of C×1. The tracking unit 204 sets a vector having the size of (5M+C)×1 obtained by connecting the modified vector to the (5M×1) vectors as the output from the tracking unit 204 in step S304. This vector having the size of (5M+C)×1 is used as the input to an estimation unit 206 in step S306.

Even in this embodiment, processing according to the flowchart in FIG. 10 is performed as processing for performed by the image processing apparatus for learning the parameter of the above neural network used at the time of inference. However, in step S1004, the second embodiment is different from the first embodiment in that the same processing as in step S304 according to this embodiment is performed.

In this manner, according to this embodiment, apparent information of the tracking target is used for precision of a movement amount at the time of inference of the lost determination reference. This makes it possible to ascertain the abruptness of the motion of the tracking target for each tracking target.

### Modification 1 of Second Embodiment

This modification includes the image feature of the tracking target candidate detected by the tracking unit and the detection unit as an input to the lost determination reference estimator. Accordingly, the apparent movement amount of the tracking target can be predicted, and at the same time the lost determination can be performed in accordance with a degree of an apparent similarity.

In this modification, a tracking unit 204 in step S304 acquires (5M×1) vectors as in the first embodiment and connects the resultant vector to the M feature vectors likely to the tracking target. The feature vector is the feature vector of the pixel of region likely to the tracking target (the region defined by the position and size included in the (5M×1) vectors) in the image feature of the search range image.

If the size (the width, height, and channel count) of the image feature of the search range image is equal to the size of the likelihood map and is given as WC×HC× C (C is a positive constant), the size of the feature vector is 1×1×C. FIG. 13B shows an example in which the likelihood map is a likelihood map 505 of FIG. 5B, and an image feature 1403 of the search range image has the size of WC (width) HC (height)×C (channel count) in a case where the pixels of the likelihood peak are pixels 506 and 507. Each of the size of a feature vector 1404 corresponding to the pixel 506 of the region likely to the tracking target in the image feature 1403 and the size of a feature vector 1405 corresponding to the pixel 507 of the region likely to the tracking target in the image feature 1403 is 1×1×C. Note that the WC, HC, and C are values determined by the structure of the neural network used by the tracker.

The tracking unit 204 modifies the feature vector having the size of 1×1×C into a feature vector having a size of C×1. The tracking unit 204 sets a vector having the size of (5M+C)×1 obtained by connecting the modified feature vector to the (5M×1) vectors as the output from the tracking unit 204 in step S304. This vector having the size of (5M+5C)×1 is used as the input to an estimation unit 206 in step S306.

Even in this modification, processing according to the flowchart in FIG. 10 is performed as processing for performed by the image processing apparatus for learning the parameter of the above neural network used at the time of inference and the weight coefficient vector. However, in step S1004, this modification is different from the first embodiment in that the same processing as in step S304 according to this modification is performed.

In this manner, according to this modification, the image feature of the tracking target candidate detected by the tracker and the detector is included at the time of inference of the lost determination reference. Accordingly, if the tracking target and the analog which are changed for each time are very similar to each other in the appearance, the lost determination is easily performed. In this manner, the lost determination in accordance with a degree of an apparent similarity can be performed.

### Third Embodiment

A method of estimating the lost determination reference in a tracking task as a combination of the detector and the tracker as in the first embodiment will be described according to the third embodiment. Differences from the first embodiment are given such that an output from the tracker of the Siam method or the like is further processed by the tracker using a time-serial model such as LSTV, and information serving as the input to the lost determination reference estimator is estimated based on the information of the past time of the tracker.

Although even in this embodiment, the processing performed by the image processing apparatus for inferring the tracking target in the image is processing according to the flowchart in FIG. 3 as in the first embodiment, the processing is different from the first embodiment in the processing in step S304. Accordingly, processing of step S304 according to this embodiment will be described below.

In this embodiment, in step S304, a tracking unit 204 acquires (5M×1) vectors as in the first embodiment, and the vector obtained by inputting these vectors to the time-series model such as LSTM is output from the tracking unit 204. In this case, use of the LSTM of Long short term memory, Sepp Hochreiter and Jurgen Schmidhuber. Neural computation, 9:1735-80, 12 1997 will be described below.

Even in this embodiment, the processing according to the flowchart in FIG. 10 is performed as the processing performed by the image processing apparatus for learning the parameter of the above neural network used at the time of inference. However, the third embodiment is different from the first embodiment in that in step S1004, the processing is performed in the same manner as in step S304 according to this embodiment.

The LSTM learning method will now be described in detail. An acquisition unit 902 acquires, as learning data, the video sequence in which one object is captured continuously with time. Here, the video sequence includes a plurality of K (K is an integer of 2 or more) images (K frames). The loss value is obtained for an image for each time as in the first embodiment, and the sum of the obtained loss values is obtained as a “1-video sequence loss value”.

An updating unit 909 updates the parameter based on the loss value of one video sequence. The updating target includes an LSTM parameter, and the weight of a fully connected layer of a hierarchical neural network as the lost determination reference estimator shown in FIG. 7, a hierarchical neural network as the lost probability estimator for performing arithmetic operation shown in equation (2), or the like.

The Back Propagation Through Time (BPTT) or the like is used as the updating method. In the BPTT, a series of serial data is input to the LSTM, and outputs are sequentially acquired. An error is then calculated for the output for each time, and the error is propagated back along the series, thereby updating the parameter. Accordingly, the parameter considering the dependence relationship of the data in the series is learned. Alternatively, a method as the truncated BPTT may be used. However, the method is not limited to this. The parameters such as the convolution layers included in the neural network constituting the tracker in a tracking unit 903 and the detector in a detection unit 904 may be fixed.

After that, the updating unit 909 stores the updated parameter of the neural network in a storage unit 104. After that, an estimation unit 905 reads out the parameter of the hierarchical neural network as the lost determination reference estimator from the storage unit 104 and sets it in the hierarchical neural network. In addition, the determination unit 906 reads out the parameter of the hierarchical neural network as the lost probability estimator from the storage unit 104 and sets it in the hierarchical neural network. In this manner, the functional unit using the neural network reads out the parameter corresponding to the neural network from the storage unit 104 and sets it in the neural network. The procedure up to this point is 1-iteration learning.

In this manner, according to this embodiment, the time-series change of the feature amount used in the estimation of the lost determination reference is expected using the tracking result of the past frame, thereby ascertaining the abruptness of the motion of the tracking target for each tracking target and for each frame. This makes it possible to reflect, on the lost determination reference, the way of changing the motion information unique to the tracking target and the likelihood.

The numerical values, the processing timings, the processing sequences, the processing entities, and the acquisition method/transmission destination/transmission source/storage location of the data (information) used in the respective embodiments are merely examples to explain the detailed examples. The present invention is not intended to be limited to these examples.

Some or all the embodiments described above may be combined and used as needed. In addition, some or all the embodiments described above may be selectively used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-066618, filed Apr. 14, 2023, which is hereby incorporated by reference herein in its entirety.

What is claimed is:

1. An image processing apparatus comprising one or more memories storing instructions and one or more processors that execute the instructions to:
acquire first information including likelihoods of tracking targets in a plurality of first candidates of the tracking target in a target image by using a tracking technique for tracking an object in an image;
acquire second information including likelihoods of tracking targets in a plurality of second candidates of the tracking target in the target image by using a detection technique for detecting an object in an image;
generate a determination reference for determining, based on the first information and the second information, whether a state is a lost state in which it is not possible to specify a tracking target; and
determine, using the determination reference, whether the target image is set in a lost state.

2. The image processing apparatus according to claim 1, wherein the one or more processors execute the instruction to acquire the first information based on a template image of a tracking target and a region of a tracking target estimated in the target image.

3. The image processing apparatus according to claim 2, wherein if a lost state is determined, the template image is updated based on the target image.

4. The image processing apparatus according to claim 2, wherein the first information includes an image feature of the template image.

5. The image processing apparatus according to claim 1, wherein the first information includes image features in a plurality of first candidates of a region of a tracking target in the target image.

6. The image processing apparatus according to claim 1, wherein information obtained by inputting the first information to a time-serial model is acquired as the first information.

7. The image processing apparatus according to claim 1, wherein second information including likelihoods of tracking targets in a plurality of second candidates of a tracking target in the target image is acquired based on the target image.

8. The image processing apparatus according to claim 1, wherein a penalty corresponding to each of the plurality of first candidates is specified based on information obtained by integrating the first information and the second information and a map of a penalty for a moving amount of the tracking target, a product between a penalty corresponding to the first candidate and a likelihood of a tracking target in the first candidate is obtained for each of the plurality of first candidates, and the determination reference is generated based on a likelihood of a tracking target in a first candidate whose value of the product becomes maximum.

9. The image processing apparatus according to claim 1, wherein a tracking result corresponding to a determination result is output as a tracking result of the tracking target in the target image, and learning of a tracker configured to acquire the first information, a detector configured to acquire the second information, an estimator configured to generate the determination reference, and an estimator configured to perform the determination is performed based on the tracking result and correct data of a region of the tracking target in the target image.

10. An image processing method performed by an image processing apparatus, comprising:
acquiring first information including likelihoods of tracking targets in a plurality of first candidates of the tracking target in a target image by using a tracking technique for tracking an object in an image;
acquiring second information including likelihoods of tracking targets in a plurality of second candidates of the tracking target in the target image by using a detection technique for detecting an object in an image;
generating a determination reference for determining, based on the first information and the second information, whether a state is a lost state in which it is not possible to specify a tracking target; and
determining, using the determination reference, whether the target image is set in a lost state.

11. A non-transitory computer-readable storage medium storing a computer program for causing a computer to function as:
a first acquisition unit configured to acquire first information including likelihoods of tracking targets in a plurality of first candidates of the tracking target in a target image by using a tracking technique for tracking an object in an image;
a second acquisition unit configured to acquire second information including likelihoods of tracking targets in a plurality of second candidates of the tracking target in the target image by using a detection technique for detecting an object in an image;
a generation unit configured to generate a determination reference for determining, based on the first information and the second information, whether a state is a lost state in which it is not possible to specify a tracking target; and
a determination unit configured to determine, using the determination reference, whether the target image is set in a lost state.
